(19) United States
(12) Patent Application Publication
(10) Pub. No.: US 2015/0361924 A1
(43) Pub. Date: Dec. 17, 2015

(54) REGULATOR HAVING ELECTRONIC VALVE INSTALLED THEREIN

(71) Applicant: DONGBANGTECH CO., LTD., Busan (KR)

(72) Inventors: Dong-jo Kim, Busan (KR); Jae-hwang Jang, Yangsan-si (KR); Hyun-chul Lee, Ulsan (KR)

(73) Assignee: DONGBANGTECH CO., LTD.

(21) Appl. No.: 14/837,233

(22) Filed: Aug. 27, 2015

Related U.S. Application Data
(63) Continuation of application No. PCT/KR2014/003481, filed on Apr. 22, 2014.

(30) Foreign Application Priority Data
Dec. 4, 2013 (KR) 10-2013-0150106

(51) Int. Cl. F02M 21/02; G05D 16/06; G05D 16/20

(52) U.S. Cl. CPC F02M 21/0239; F02M 21/0233; G05D 16/2013; G05D 16/06

(57) ABSTRACT

The present invention relates to a regulator having an electronic valve installed therein. The A regulator having an electronic valve installed therein, the regulator including: a first pressure reducing part connected to an inlet port; and a second pressure reducing part connected to the first pressure reducing part, wherein the second pressure reducing part includes: a pressure reducing chamber into which fuel is introduced from the first pressure reducing part; an orifice formed in the pressure reducing chamber; a valve shaft for opening and closing the orifice; a diaphragm for moving the valve shaft by use of an input pressure and an output pressure; and a spring for resiliently supporting the diaphragm, wherein an auxiliary conduit is formed to interconnect the pressure reducing chamber and an upper space of the diaphragm, and an electronic valve for controlling the pressure of an outlet port is installed on the auxiliary conduit.

### REFERENCE TO RELATED APPLICATIONS

This is a continuation of pending International Patent Application PCT/KR2014/003481 filed on Apr. 22, 2014, which designates the United States and claims priority of Korean Patent Application No. 10-2013-0150106 filed on Dec. 4, 2013, the entire contents of which are incorporated herein by reference.

### FIELD OF THE INVENTION

The present invention generally relates to a regulator and, more particularly, to a regulator for controlling fuel pressure using first and second pressure reducing parts, the regulator having an electronic valve therein for maintaining the fuel pressure at a constant level.

### BACKGROUND OF THE INVENTION

In general, a regulator is installed in a car using compressed hydrogen gas or compressed natural gas as fuel, and reduces high fuel pressure formed in a fuel inlet port to a prescribed level when fuel is supplied from the fuel storage tank into the inlet port.

This regulator is widely used for a compressed natural gas car as disclosed in, for example, Korean Patent Application Nos. 10-2009-0099639 and 10-2010-0124051.

In recent years, most regulators are configured to reduce high fuel pressure in two steps, rather than directly reducing the pressure in one step.

In the related art technologies, the regulators perform the pressure reduction process in two steps using first and second pressure reducing parts, each of which has an orifice, so that the regulators reduce high fuel pressure to an appropriate output level required by an engine.

These related art technologies, however, have difficulty in maintaining the output fuel pressure at a constant level.

### SUMMARY OF THE INVENTION

Accordingly, the present invention has been made keeping in mind the above problems occurring in the related art, and the present invention is intended to propose a regulator that has an electronic valve and can constantly maintain the output pressure of gas fuel at a constant level through a two-step pressure reduction process.

In order to achieve the above object, according to one aspect of the present invention, there is provided a regulator having an electronic valve installed therein, the regulator including: a first pressure reducing part connected to an inlet port; and a second pressure reducing part connected to the first pressure reducing part, wherein the second pressure reducing part includes: a pressure reducing chamber into which fuel is introduced from the first pressure reducing part; an orifice formed in the pressure reducing chamber; a valve shaft for opening and closing the orifice; a diaphragm for moving the valve shaft by use of an input pressure and an output pressure; and a spring for resiliently supporting the diaphragm, wherein an auxiliary conduit is formed to interconnect the pressure reducing chamber and an upper space of the diaphragm, and an electronic valve for controlling the pressure of an outlet port is installed on the auxiliary conduit.

Here, the electronic valve may include: a coil; a core secured inside the coil; a plunger provided with a seat part that is combined with a lower part of the plunger and is in contact with a seal contact part formed on the auxiliary conduit; a spring provided between the plunger and the core; and a seal O-ring coupled to an upper surface of the plunger.

In another aspect of the present invention, there is provided a regulator having an electronic valve installed therein, the regulator including: a first pressure reducing part connected to an inlet port; and a second pressure reducing part connected to the first pressure reducing part, wherein the second pressure reducing part includes: a pressure reducing chamber into which fuel is introduced from the first pressure reducing part; an orifice formed in the pressure reducing chamber; a valve shaft for opening and closing the orifice; a diaphragm for moving the valve shaft by use of an input pressure and an output pressure; and a spring for resiliently supporting the diaphragm, wherein an auxiliary conduit is formed to interconnect the pressure reducing chamber and an outlet port, and an electronic valve for controlling the pressure of the outlet port is installed on the auxiliary conduit.

According to the present invention having the above-described characteristics, it is possible to maintain the pressure at the outlet port at a constant level by installing an electronic valve on the auxiliary fluid conduit formed on the second pressure reducing part.

### BRIEF DESCRIPTION OF THE DRAWINGS

FIG. 1 is a perspective view showing a regulator having an electronic valve according to an exemplary embodiment of the present invention,

FIG. 2 is a cross-sectional view of FIG. 1,

FIG. 3 is a cross-sectional view of the electronic valve according to the exemplary embodiment of the present invention, and

FIGS. 4 and 5 are cross-sectional views, respectively showing the operation of the valve of FIG. 3.

### DETAILED DESCRIPTION OF THE INVENTION

Reference will now be made in greater detail to an exemplary embodiment of the present invention, an example of which is illustrated in the accompanying drawings.

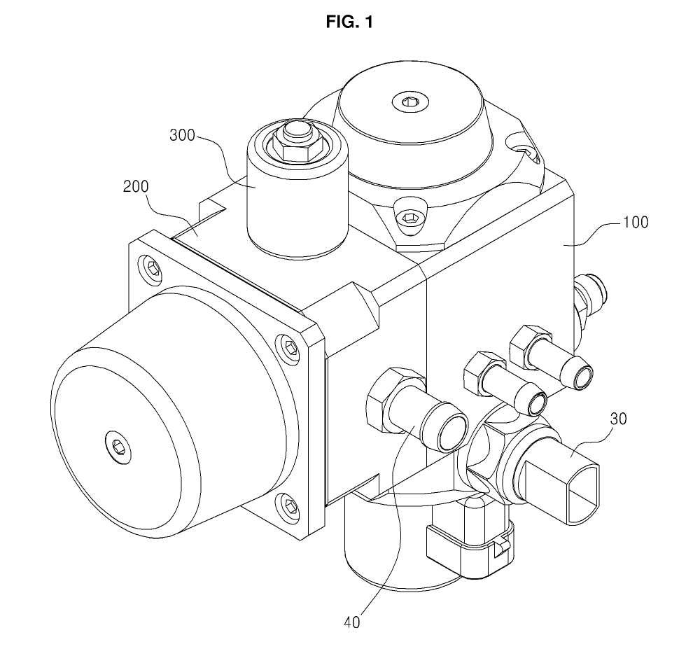

FIG. 1 is a perspective view of a regulator having an electronic valve according to an exemplary embodiment of the present invention.

In the regulator having an electronic valve according to the present invention, the pressure of fuel gas introduced through an inlet port 30, is successively reduced by a first pressure reducing part 100 and a second pressure reducing part 200, and is discharged to an outlet port 40 in a decompressed state. Here, the decompressed output pressure of the second pressure reducing part 200 is controlled at a constant level by an electronic valve 300.

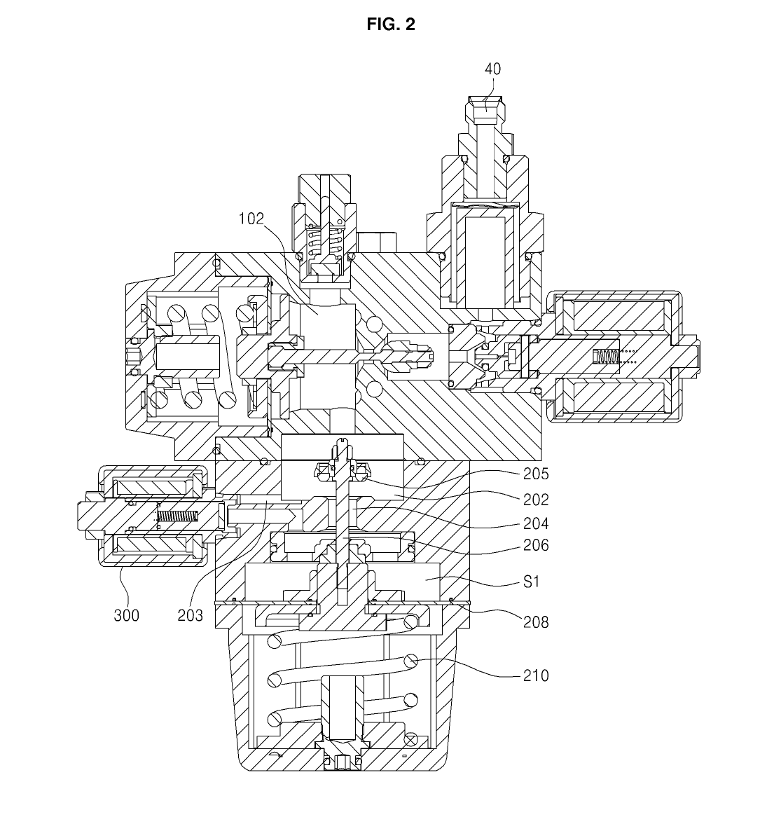

FIG. 2 is a sectional view of FIG. 1.

In the regulator having an electronic valve according to the present invention, fuel gas introduced through the inlet port 30 is decompressed primarily in a pressure reducing chamber 102 of the first pressure reducing part, and this primarily decompressed fuel gas is fed to a second pressure reducing chamber 202, as shown in FIG. 2.

In the pressure reducing chamber 202 of the second pressure reducing part, an orifice 204 is formed, and a contact seat part 205 is provided at an end of a valve shaft 206 that opens and closes the orifice 204.

The regulator further includes a diaphragm 206 for moving the valve shaft 206. The diaphragm 206 controls the movement of the valve shaft 206 by use of the input and output pressures of the fuel gas, and is resiliently supported by a spring 210 for adjusting the preset pressure.

The regulator having an electronic valve according to the present invention further includes an auxiliary conduit 203 that interconnects the pressure reducing chamber 202 and an upper space s1 of the diaphragm, and an electronic valve 300 is installed on the auxiliary conduit 202 so as to control the output pressure in the outlet port.

The electronic valve will now be described in more detail.

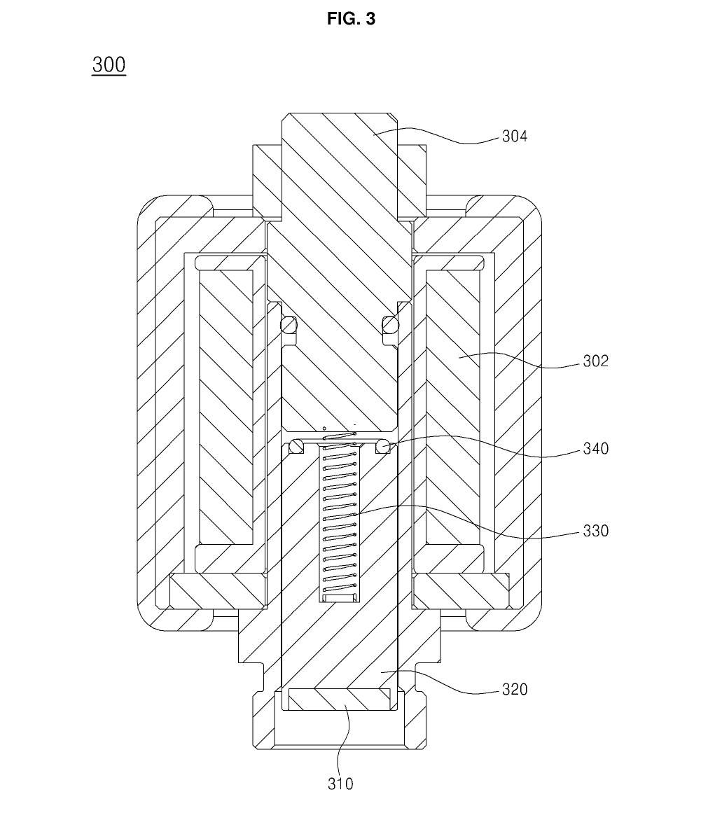

FIG. 3 is a sectional view showing an embodiment of the electronic valve according to the present invention.

As shown in FIG. 3, the electronic valve may be a PWM (Pulse Width Modulation) valve or a solenoid valve.

More specifically, the electronic valve 300 includes: a coil 302; a core 304 secured inside the coil 302; a plunger 320 provided with a seat part 310 that is combined with a lower part of the plunger and is in contact with a seal contact part formed on the auxiliary conduit; a spring 330 provided between the plunger 320 and the core 302; and a seal O-ring 340 coupled to the upper surface of the plunger 320.

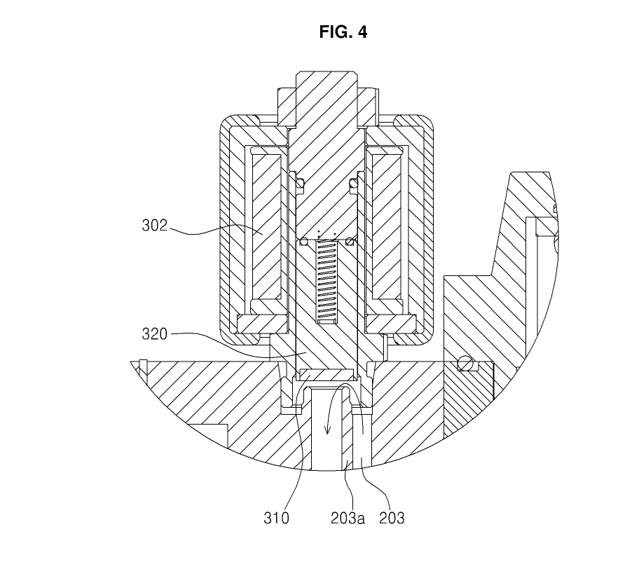

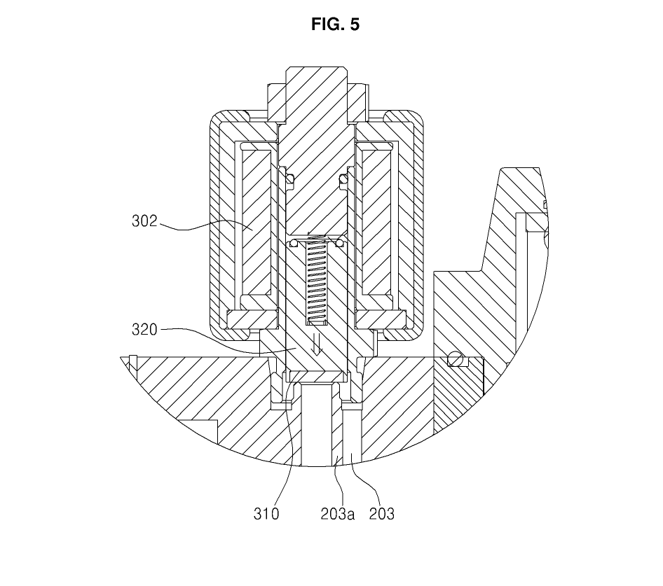

FIGS. 4 and 5 are cross-sectional views, respectively showing the operation of the valve of FIG. 3.

As shown in FIG. 4, when the auxiliary conduit 203 is open, fuel gas is fed to the upper space of the diaphragm and the decompressed pressure thereof is controlled, so that the output pressure of the fuel is increased.

Then, in the electronic valve, an electric current is applied to the coil 302 so that an electronic magnet is formed in the valve and the core 304 repels the plunger 320, thereby moving the plunger 320, as shown in FIG. 5.

Thus, the movement of the plunger 320 brings the seat part 310 into contact with the seal contact part 203a, thereby closing the auxiliary conduit.

Unlike the embodiment shown in FIG. 3, the auxiliary conduit may be provided so as to interconnect the pressure reducing chamber and the outlet port, and the electronic valve for controlling the output pressure of the outlet port may be installed on the auxiliary conduit.

As described above, the present invention primarily suggests a technical concept of a regulator having an electronic valve installed therein.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

The present invention relates to a regulator, and is applicable to a regulator having an electronic valve installed therein, formed by installing an electronic valve in the regulator controlling the pressure of fuel gas through first and the second pressure reducing parts, thereby maintaining the output pressure at a constant level.

What is claimed is:

1. A regulator having an electronic valve installed therein, the regulator comprising: a first pressure reducing part connected to an inlet port; and a second pressure reducing part connected to the first pressure reducing part,
wherein the second pressure reducing part includes: a pressure reducing chamber into which fuel is introduced from the first pressure reducing part; an orifice formed in the pressure reducing chamber; a valve shaft for opening and closing the orifice; a diaphragm for moving the valve shaft by use of an input pressure and an output pressure; and a spring for resiliently supporting the diaphragm,
wherein an auxiliary conduit is formed to interconnect the pressure reducing chamber and an upper space of the diaphragm, and an electronic valve for controlling the pressure of an outlet port is installed on the auxiliary conduit.

2. The regulator as claimed in claim 1, wherein the electronic valve comprises: a coil; a core secured inside the coil; a plunger provided with a seat part that is combined with a lower part of the plunger and is in contact with a seal contact part formed on the auxiliary conduit; a spring provided between the plunger and the core; and a seal O-ring coupled to an upper surface of the plunger.

3. A regulator having an electronic valve installed therein, the regulator comprising: a first pressure reducing part connected to an inlet port; and a second pressure reducing part connected to the first pressure reducing part,
wherein the second pressure reducing part includes: a pressure reducing chamber into which fuel is introduced from the first pressure reducing part; an orifice formed in the pressure reducing chamber; a valve shaft for opening and closing the orifice; a diaphragm for moving the valve shaft by use of an input pressure and an output pressure; and a spring for resiliently supporting the diaphragm,
wherein an auxiliary conduit is formed to interconnect the pressure reducing chamber and an outlet port, and an electronic valve for controlling the pressure of the outlet port is installed on the auxiliary conduit.
